(19) United States
(12) Patent Application Publication
(10) Pub. No.: US 2013/0043169 A1
(43) Pub. Date: Feb. 21, 2013

(54) Separator

(71) Applicant: Anthony C. Horton, II, Los Angeles, CA (US)

(72) Inventor: Anthony C. Horton, II, Los Angeles, CA (US)

(21) Appl. No.: 13/361,525

(22) Filed: Jan. 30, 2012

Related U.S. Application Data
(60) Provisional application No. 61/462,116, filed on Jan. 28, 2011.

(51) Int. Cl. A01B 1/20; A01B 1/02; B07B 1/02

(52) U.S. Cl. 209/419

(57) ABSTRACT

The invention provides a device designed to turn a shove blade into a sifting tool. The Separator allows water, mud, sand and fine materials to escape through the openings in the scoop or blade, while larger and heavier materials remain in the shovel blade. The Separator comprises contractor grade, square bladed transfer shovels having openings in the scoop. The edges of the blade are manufactured from a fool grade and tempered steel. The scoop is comprised of a steel grate which can be made in various diameter gauges.

### FIELD OF THE INVENTION

The present invention pertains to the field of tools, and more specifically to the field of shovels and sieves.

### BACKGROUND OF THE INVENTION

The prior art has put forth several designs for shovels and sieves. Among these are:

U.S. Pat. No. 5,810,407 to James R. Melendez and Jacob Lloyd Neet describes a shovel with a rigid and perforated blade.

U.S. Pat. No. 5,383,696 to Guenter O. Speier describes a grid shovel with serrated edges also used for raking and weeding.

U.S. Pat. No. 1,234,835 to William R. Watkins describes a shovel comprising a sieved blade with a removable solid bottom.

None of these prior art references describe the present invention.

### SUMMARY OF THE INVENTION

It is an object of the present invention to provide an improved heavy duty shovel with a grated or meshed blade for sifting out smaller materials and draining water.

### BRIEF DESCRIPTION OF THE DRAWINGS

FIG. 1 is a perspective top view of the present invention showing the handle and grated shovel blade.

FIG. 2 is a zoom view showing the grated shovel blade and its attachment to the handle.

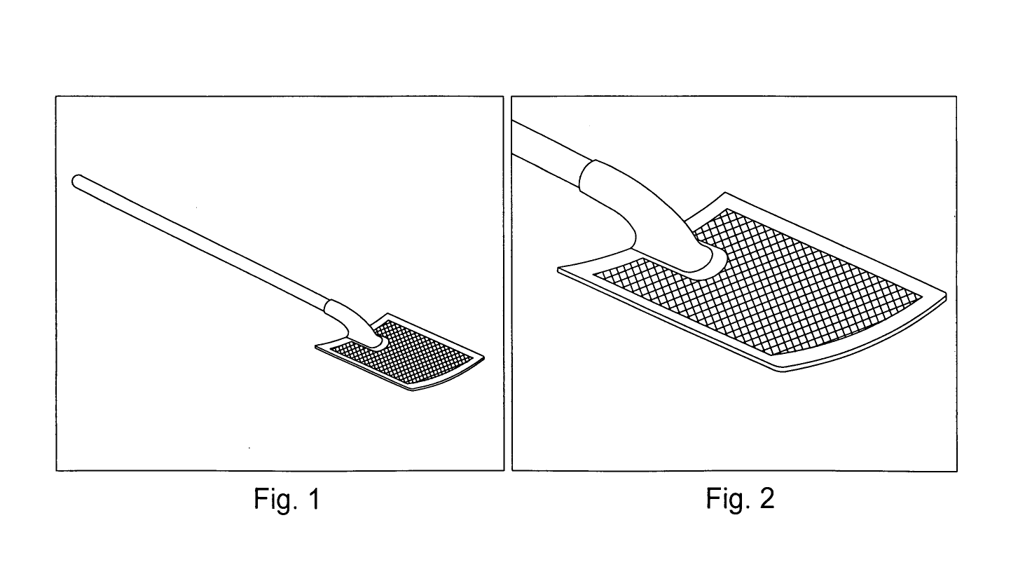

### DETAILED DESCRIPTION OF THE INVENTION

Shovels are efficient tools for easily transferring debris and other materials. A wide variety of shovels are available and well established in usage and functionality. The existing shovels with solid heads and blades are great for digging up solid materials. An improved shovel design is needed for shoveling gravel from a trench filled with water, mixing cement and water in a wheelbarrow, or removing debris from ditches and canals.

The present invention, hereinafter referred to as The Separator, is designed to turn the shovel blade into a sifting tool. The Separator allows water, mud, sand and fine materials to escape through the openings in the scoop or blade, while larger and heavier materials remain in the shovel blade. The Separator comprises contractor grade, square bladed transfer shovels having openings in the scoop. The edges of the blade are manufactured from a tool grade and tempered steel. The scoop is comprised of a steel grate which can be made in various diameter gauges. A specific grate gauge holds materials larger than a specific diameter and lets materials smaller than that diameter pass through the blade. Larger, heavier materials such as gravels or rocks remain in the scoop to be more easily and efficiently transferred from one location to another.

The Separator features a straight wood handle and a squared scoop blade, with a total length of approximately fifty-nine inches and a blade width of approximately nine and one half inches to ten and three quarters inches. The steel grate or mesh comprising the interior of the scoop is welded to the steel edges of the blade. As noted earlier, the grate's gauge can vary according to the needed sifting capacity. The Separator which is designed to retain pea gravel and to drain water, mud, and sand, possesses a closely spaced grate. The Separator designed to remove storm drain debris from the banks of a canal or drainage ditch possesses a widely spaced grate. The receiving tube of the shovel-head, is extended for strength. Handles are easily replaced with commercially available handles. In an alternative embodiment, the Separator offers a series of interchangeable Separator blades in various grate gauges. The user shifts the shovel handle from blade to blade as necessary.

The Separator sifting transfer shovels, presents do-it-yourself homeowners, workers in the construction industry, and landscaping contractors and workers with a tool specifically matched to the job at hand. Consider the worker on a storm drainage project where gravel must be shoveled and moved from a water filled trench. With a solid head shovel, this worker will move loads of gravel and also gallons of water. Using The Separator, the same worker can move the loads of gravel, and let the water quickly and easily drain out. The Separator saves this worker both time and effort and helps the contractor's bottom line as well. Another example is the worker who uses a solid head shovel to mix a wheelbarrow load of cement. Moving the solid shovel-head through the heavy, viscous cement takes strength, stamina and time. The Separator functions like a mechanical mixer, moving more easily through the material, allowing the cement to flow through the grated expanse of the shovel head, and making this tough job a lot easier. The Separator will be a help to road clean-up crews, landscapers, and household gardeners as well. The Separator enables such workers to pick up and remove larger gravels, rocks and debris without the added volume and weight of water, mud, silt and sand. The need for a separate sifting apparatus is eliminated. The trash bags or trash cans for deposing the debris are lighter in weight and easier to handle. The gardener planting a rosebush can remove the rocks from the planting hole and leave the valuable soil behind. The Separator is constructed of contractor grade and high quality materials. It is designed for easy handle replacement and produced various grate gauges for the utmost in versatility. The Separator is priced affordably and competitively, is a tool of uncommon utility for construction personnel, landscapers, and home do-it-yourselfers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A grated shovel device having openings in the scoop, used in sifting and transferring materials, comprising a square bladed transfer shovel having openings in the scoop, wherein the edges of the blade are manufactured from a tool grade and tempered steel.

2. The device of claim 1 wherein the scoop is comprised of a steel grate wherein the openings of the grate can be made in various diameter gauges.

3. The device of claim 1 further comprising a straight wood handle and a squared scoop blade, with a total length of approximately fifty-nine inches and a blade width of approximately nine and one half inches to ten and three quarters inches.

4. The device of claim 1 wherein the steel grate or mesh comprising the interior of the scoop is welded to the steel edges of the blade.

5. The device of claim 1 designed to retain pea gravel and to drain water, mud, and sand, comprising a closely spaced grate.

6. The device of claim 1 designed to remove storm drain debris from the banks of a canal or drainage ditch comprises a widely spaced grate, and further comprising an extended receiving tube of the shovel head for extra strength.

7. The device of claim 1 having a replaceable handle.

8. the device of claim 1 comprising a plurality of interchangeable blades in various grate gauges, wherein a user changes the shovel blade as necessary.
